(19) United States
(12) Patent Application Publication
(10) Pub. No.: US 2017/0216924 A1
(43) Pub. Date: Aug. 3, 2017

(54) GAS PHASE SYNTHESIS OF STABLE SOFT MAGNETIC ALLOY NANOPARTICLES

(71) Applicant: Okinawa Institute of Science and Technology School Corporation, Okinawa (JP)

(72) Inventors: Jerome VERNIERES, Okinawa (JP); Maria BENELMEKKI ERRETBY, Okinawa (JP); Jeong-Hwan KIM, Okinawa (JP); Rosa Estela DIAZ RIVAS, Okinawa (JP); Mukhles Ibrahim SOWWAN, Okinawa (JP)

(73) Assignee: Okinawa Institute of Science and Technology School Corporation, Okinawa (JP)

(21) Appl. No.: 15/501,309

(22) PCT Filed: Aug. 6, 2015
(86) PCT No.: PCT/JP2015/003973

§ 371 Date: Feb. 2, 2017

Related U.S. Application Data
(60) Provisional application No. 62/034,498, filed on Aug. 7, 2014.

(51) Int. Cl. B22F 9/12; H01F 1/153; C22C 38/06; B22F 1/02; B22F 1/00

(52) U.S. Cl. CPC B22F 9/12; B22F 1/02; B22F 1/0062; B22F 1/0044; C22C 38/06; H01F 1/15341; H01F 1/153; B22F 2201/11; B22F 2202/05; B22F 2301/35; B22F 2302/253; B22F 2302/45; B22F 2998/10

(57) ABSTRACT

A soft magnetic nanoparticle comprising an iron aluminide nanoalloy of the DO₃ phase as a core encapsulated in an inert shell made of alumina.

### TECHNICAL FIELD

The present invention relates to gas phase synthesis of stable soft magnetic alloy nanoparticles. This application hereby incorporates by reference U.S. Provisional Application No. 62/034,498, filed Aug. 7, 2014, in its entirety.

### BACKGROUND

In the past century, soft magnetic alloys have been intensively investigated for a wide range of applications such as power transformers, inductive devices, magnetic sensors, etc., (see Non-patent literatures NPLs 1 and 2). In the era of nanotechnology, soft magnetic materials with nanoscale dimensions are highly desirable. It would require uniform bimetallic nanoalloys with soft magnetic behavior to answer this technological demand.

### CITATION LIST

### Non Patent Literature

NPL 1: A. Makino, T. Hatanai, Y. Naitoh, T. Bitoh, A. Inoue and T. Masumoto, IEEE T. Mag., 1997, 33, 3793-3798.
NPL 2: T. Osaka, M. Takai, K. Hayashi, K. Ohashi, M. Saito and K. Yamada, Nature, 1998, 392, 796-798.
NPL 3: O. Margeat, D. Ciuculescu, P. Lecante, M. Respaud, C. Amiens and B. Chaudret, small, 2007, 3, 451-458.
NPL 4: M. Benelmekki, M. Bohra, J.-H. Kim, R. E. Diaz, J. Vernieres, P. Grammatikopoulos and M. Sowwan, Nanoscale, 2014, 6, 3532-3535.
NPL 5: V. Singh, C. Cassidy, P. Grammatikopoulos, F. Djurabekova, K. Nordlund and M. Sowwan, J. Phys. Chem. C., 2014, ASAP.
NPL 6: H. Graupner, L. Hammer, K. Heinz and D. M. Zehner, Surf. Sci., 1997, 380, 335-351.
NPL 7: E. Quesnel, E. Pauliac-Vaujour and V. Muffato, J. Appl. Phys., 2010, 107, 054309.
NPL 8: J. F. Moulder, W. F. Stickle, P. E. Sobol, K. D. Bomben, Handbook of X-ray photoelectron spectroscopy, ISBN 0-9627026-2-5 ED Jill Chastain. Pub. Perkin Elmer Corporation, 1992.
NPL 9: T. Yamashita and P. Hayes, Appl. Surf. Sci., 2008, 254, 2441-2449.
NPL 10: G. A. Castillo Rodriguez, G. G. Guillen, M. I. Mendivil Palma, T. K. Das Roy, A. M. Guzman Hernandez, B. Krishnan and S. Shaji, Int. J. Appl. Ceram. Technol., 2014, 11, 1-10.
NPL 11: Y. B. Pithwalla, M. S. El-Shall, S. C. Deevi, V. Strom and K. V. Rao, J. Phys. Chem. B, 2001, 105, 2085-2090.
NPL 12: K. Suresh, V. Selvarajan and I. Mohai, Vaccum, 2008, 82, 482-490.
NPL 13: S. Chen, Y. Chen, Y. Tang, B. Luo, Z. Yi, J. Wei and W. Sun, J. Cent. South Univ., 2013, 20, 845-850.
NPL 14: M. Kaur, J. S. McCloy, W. Jiang, Q. Yao and Y. Qiang, J. Phys. Chem. C, 2012, 116, 12875-12885.
NPL 15: N. A. Frey, S. Peng, K. Cheng and S. Sun, Chem. Soc. Rev., 2009, 38, 2535-2542.
NPL 16: A. Meffre, B. Mehdaoui, V. Kelsen, P. F. Fazzini, J. Caney, S. Lachaize, M. Respaud and B. Chaudret, Nano Lett., 2012, 12, 4722-4728.
NPL 17: G. Huang, J. Hu, H. Zhang, Z. Zhou, X. Chi and J. Gao, Nanoscale, 2014, 6, 726-730.
NPL 18: P. Tartaj, M. del Puerto Morales, S. Veintemillas-Verdaguer, T. Gonzalez-Carreno and C. J Serna, J. Phys. D: Appl. Phys., 2003, 36, R182-R197.
NPL 19: L. Zhang, F. Yu, A. J. Cole, B. Chertok, A. E. David, J. Wang and V. C. Yang, The APPS Journal, 2009, 11, 693-699.
NPL 20: H. Zhang, G. Shan, H. Liu and J. Xing, Surf. Coat. Tech., 2007, 201, 6917-6921.
NPL 21: J. Yang, W. Hu, J. Tang and X. Dai, Comp. Mater. Sci., 2013, 74, 160-164.
NPL 22: X. Shu, W. Hu, H. Xiao, H. Deng and B. Zhang, J. Mater. Sci. Technol., 2001, 17, 601-604.

### SUMMARY OF INVENTION

### Technical Problem

However, when bimetallic systems are considered at the nanoscale, oxidation, phase segregation, and agglomeration due to inter-particle magnetic interactions are expected, resulting in the alteration of magnetic properties and raising the question of the feasibility of soft magnetic nanoalloys (NPL 3)

Accordingly, the present invention is directed to gas phase synthesis of stable soft magnetic alloy nanoparticles. In particular, in one aspect, the present disclosure provides a novel approach to overcome the limitations of the exiting art.

An object of the present invention is to perform gas phase synthesis of stable soft magnetic alloy nanoparticles in a reasonably inexpensive, well-controlled manner. Another object of the present invention is to provide stable soft magnetic alloy nanoparticles that obviate one or more of the problems of the prior art.

### Solution to Problem

To achieve these and other advantages and in accordance with the purpose of the present invention, as embodied and broadly described, in one aspect, the present invention provides a soft magnetic nanoparticle comprising an iron aluminide nanoalloy of the DO₃ phase as a core encapsulated in an inert shell made of alumina.

In another aspect, the present invention provides a method for forming soft magnetic nanoparticles each comprising an iron aluminide nanoalloy of the DO₃ phase as a core encapsulated in an inert shell made of alumina, the method comprising: producing a supersaturated vapor of metal atoms of Al and Fe in an aggregate zone by co-sputtering Fe atoms and Al atoms in an Ar atmosphere; producing larger nanoparticles from the supersaturated vapor; causing the larger nanoparticles to pass through an aperture with a pressure differential before and after the aperture so as to create a nan-ocluster beam of the nanoparticles emerging from the aperture; and directing the nan-ocluster beam to a substrate to deposit the nanoparticles onto the substrate.

### Advantageous Effects of Invention

According to the present invention, it becomes possible to provide stable soft magnetic alloy nanoparticles that have a wide range of industrial applicability.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It is to be understood that both the foregoing general description and the following detailed description are exemplary and explanatory, and are intended to provide further explanation of the invention as claimed.

### BRIEF DESCRIPTION OF DRAWINGS

FIG. 1 shows morphology and chemical composition of manufactured nanoparticles according to an embodiment of the present invention. FIG. 1, (a) is a SEM image of the as-deposited nanoparticles. FIG. 1, (b) shows a size distribution of the nanoparticles showing an average diameter of 10.8 nm+−2.5 nm. FIG. 1, (c) is a TEM micrograph revealing a distinctive core-shell structure. FIG. 1, (d) is an ADF-STEM image of a representative nanoparticle. FIG. 1, (e) is EELS line profiles along the nanoparticle for FeL_{2,3}(707 eV), Al L_{2,3} (76 eV) and O K (532 eV) , showing that the core contains high concentration of Fe and Al, while the shell is composed mainly of Al and O.

FIG. 2 shows the observed crystal structure of the nanoparticles according to the embodiment of the present invention. FIG. 2, (a) shows an HRTEM micrograph image, showing the single crystalline core with interplanar distance of 2.03 angstroms encapsulated in an amorphous shell. FIG. 2, (b) is the corresponding FFT and FIG. 2, (c) is an electron diffraction pattern in the [00-1] zone axis orientation calculated by Crystal Maker™ software. The structure can be assigned to the DO₃ phase.

FIG. 3 shows composition and oxidation states of the nanoparticles according to the embodiment of the present invention measured by XPS, showing photoemission spectra and curve fittings for the Al 2p region (a), for the Fe 2p region (b), for the Fe 3p regions (c), and for the O 1s region (d), after exposure to air.

FIG. 4 is a measured normalized magnetization as a function of magnetic field. The outer lines indicate the magnetization at 5K and the inner lines at 300 K.

FIG. 5 shows a size distribution (a) measured using dynamic light scattering (DLS) and zeta potential measurements (b), of iron aluminide nanoparticles coated with GA in water according to an embodiment of the present invention.

FIG. 6 is a schematic diagram of a modified inert-gas condensation magnetron co-sputtering apparatus used to manufacture soft magnetic nanoparticles of embodiments of the present invention.

FIG. 7 shows EELS spectra obtained from different areas of a representative nanoparticle according to an embodiment of the present invention. FIG. 7, (a) shows core-loss spectra for the measured areas 1-3 (shown in the image on the right), and (b) shows low-loss spectra for the areas 1-3.

FIG. 8 shows simulated X-ray powder diffraction pattern (a) of the DO₃ structure (b) and the corresponding electron diffraction pattern in [00-1] zone axis (c).

FIG. 9 schematically shows a harvesting procedure employed for the magnetic nanoparticles coated with Gum Arabic (GA).

### DESCRIPTION OF EMBODIMENTS

The present disclosure provides a novel approach to overcome the limitations of the existing art. In one aspect, the present disclosure provides a general approach to gas phase synthesis of stable soft magnetic alloy nanoparticles. Iron aluminide nanoalloys of the DO₃ phase encapsulated in alumina shell were manufactured using co-sputter inert gas condensation technique. The role of the inert shell is to reduce the inter-particle magnetic interactions and prevent further oxidation of the crystalline core. The nanoparticles display high saturation magnetization (170 emu/g) and low coercivity (>20 Oe) at room temperature. The surface of these nanoparticles could be modified with polymer, such as gum arabic (GA), to ensure their good colloidal dispersion in aqueous environments.

High-resolution transmission electron microscopy (HRTEM), scanning electron microscopy (SEM), aberration-corrected scanning transmission electron microscopy (STEM), and electron energy loss spectroscopy (EELS) were employed to examine the nanoparticles morphology, structure, and composition of the resulting soft magnetic alloy nanoparticles.

X-ray photoelectron spectroscopy (XPS) was used to determine the oxidation state of the Fe and Al. Magnetization measurements using vibrating sample magnetometer (VSM) at different temperatures were carried out to evaluate the magnetic behavior of the nanoparticles.

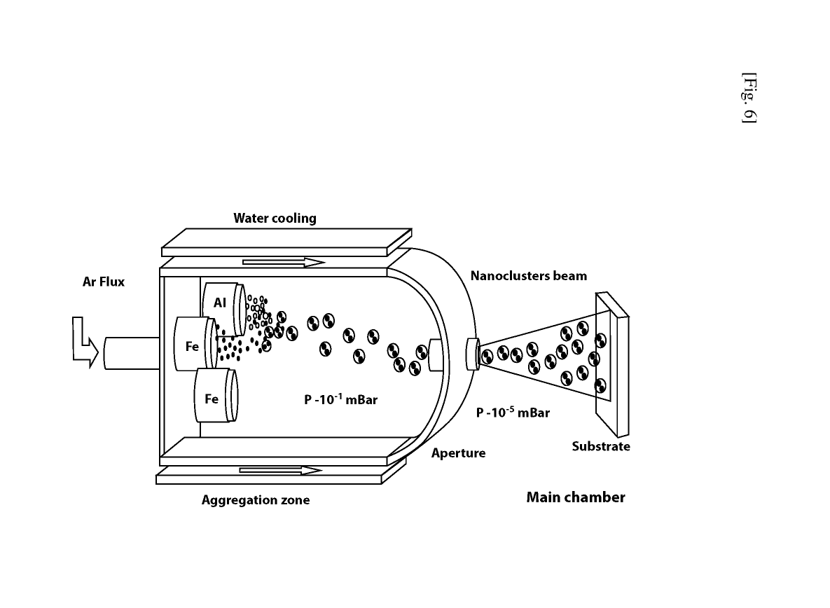

In an embodiment of the present invention, nanoparticles were fabricated via gas aggregated co-sputtering (NPLs 4 and 5) of Fe and Al from two independent neighboring targets on a silicon substrate in high vacuum chamber. Details of the manufacturing setup and conditions will be provided later in this disclosure. The main advantages of this method are that: (1) oxidation at low rates (high vacuum conditions and room temperature in the main chamber, which will be described with reference to FIG. 6 below) leads to segregation of pure alumina shell (NPL 6)^{;} and (2) the desired chemical composition of the nanoparticles can be obtained by controlling the volume fraction of each element. In the configuration made by the present inventors, this was achieved by tuning the magnetron power applied on each target (Fe and Al) independently while co-sputtering.

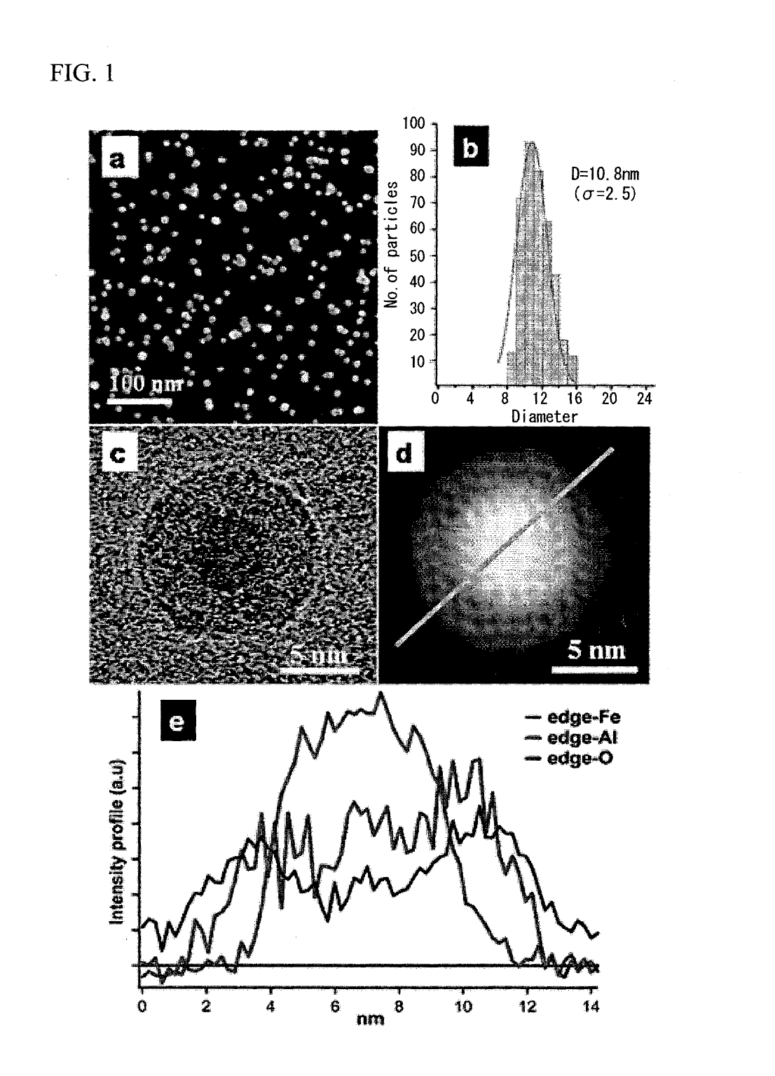

FIG. 1 shows morphology and chemical composition of the manufactured nanoparticles. FIG. 1, (a) is a SEM image of the as- deposited nanoparticles. FIG. 1, (b) shows a size distribution of the nanoparticles showing an average diameter of 10.8 nm+−2.5 nm. FIG. 1, (c) is a TEM micrograph image of one nanoparticle. FIG. 1, (d) is an ADF-STEM image of a representative nanoparticle. FIG. 1, (e) is EELS line profiles along the line drawn in (d). As shown in FIG. 1, (a) and (b), the nanoparticles are monodispersed and show no signs of agglomeration with an average diameter of 10.8 nm +−2.5 nm. TEM and STEM images (FIG. 1, (c) and (d), respectively) show that the nanoparticles have uniform spherical shape with distinctive core-shell structure. The EELS line profile (FIG. 1, (e)) taken along the line indicated FIG. 1, (d) reveals a high concentration of Fe (FeL_{2,3}at 707 eV) and Al (Al L_{2,3} at 76 eV) in the core, while the shell is composed mainly of Al and O (OK at 532 eV).

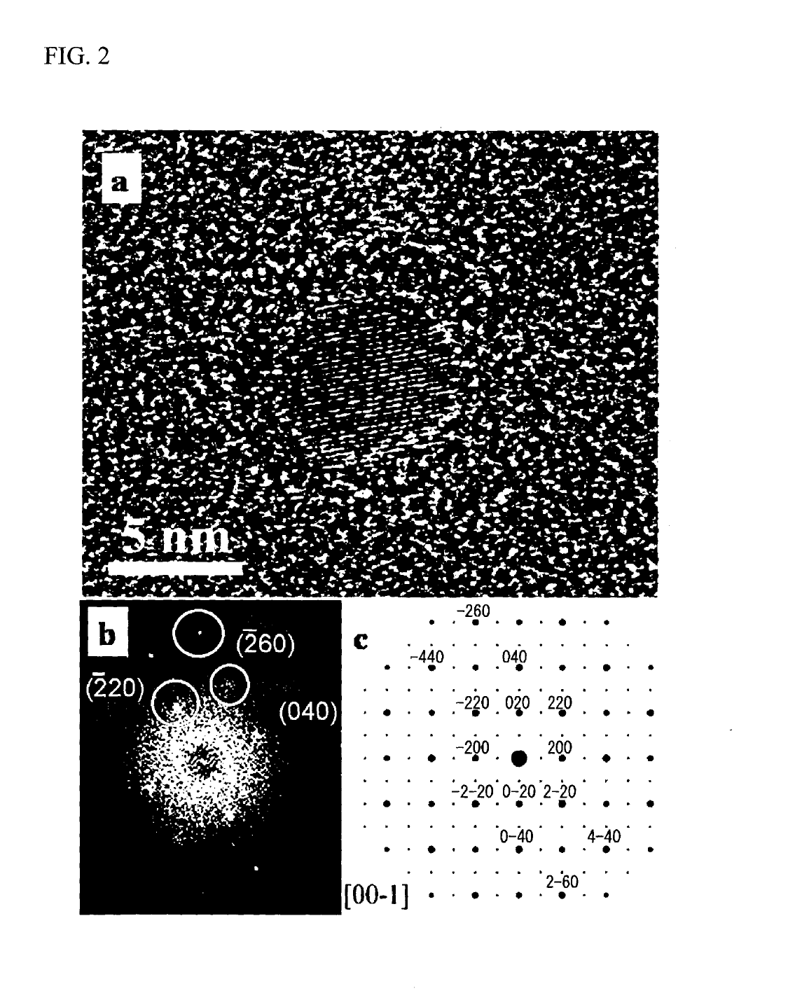

High-resolution TEM (HRTEM) image (FIG. 2, (a)) indicates that the core is crystalline while the shell is amorphous. The interplanar distance estimated from the lattice fringes is found to be 2.03 angstroms, which can be assigned to the Fe-rich A2, the B2 or DO₃ phase. However, the high temperature ordered B2 phase is not expected in this case due to the relatively low temperature of the gas-phase involve in an inert gas condensation technique (NPL 7). The Fast Fourier Transform (FFT) of the HRTEM lattice of the core shown in FIG. 2, (b) with the electron diffraction pattern in the [00-1] zone axis orientation calculated by Crystal Maker software (FIG. 2, (c)) confirmed the presence of the DO₃ phase.

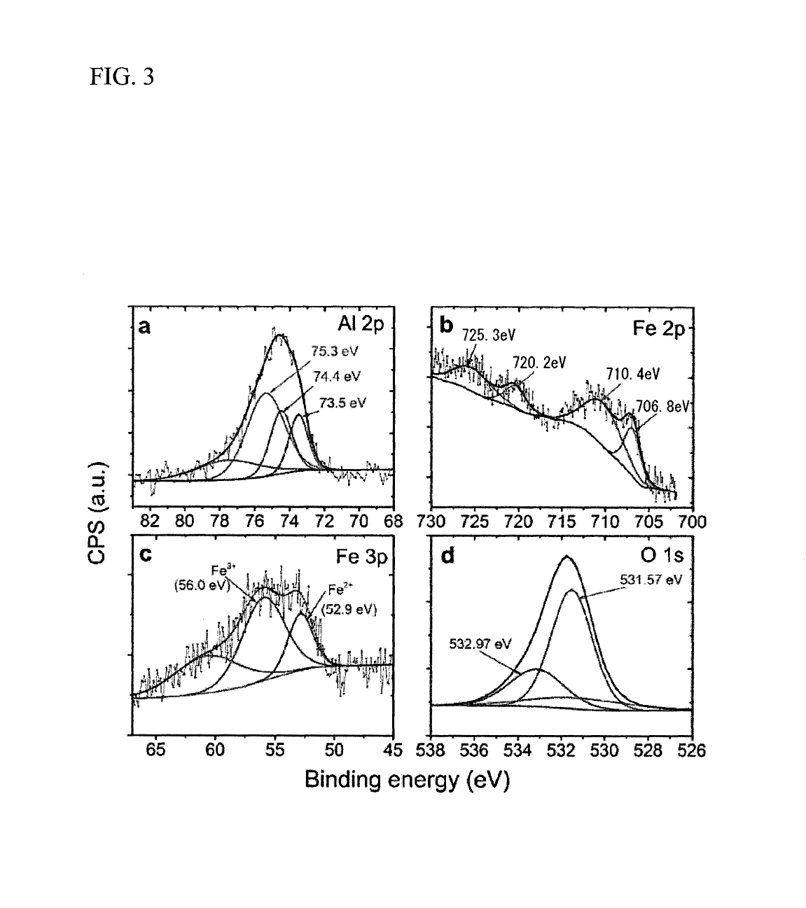

XPS core level spectra Al2p, Fe2p, Fe3p and O1s are measured and plotted in FIG. 3, (a)-(d), respectively. The spectra show that Fe and Al are present in both metallic (73.5 eV and 706.8 eV) and oxide (74.4 eV and 710.4 eV) states. The ratio between the peak areas of metallic Al2p (73.5 eV) and Fe2p (706.8 eV) is about 27%, corresponding to the DO₃ phase (Fe₇₃Al₂₇) in the binary phase diagram of iron aluminide.

Moreover, the peak corresponding to metallic Al (FIG. 3, (a)) is found to shift towards higher binding energy (73.4 eV instead of 72 eV), which suggests Al atoms coordination to Fe atoms. This matches exactly the reported value of the Fe₃Al phase (NPLs 6 and 8). The peak at 75.3 eV binding energy (FIG. 3 (a)) is an indication of formation of Al₂O₃ on the surface. The same conclusion can be drawn from the O 1 s peak (FIG. 3, (d)) at 532.97 eV, which corresponds to the reported value for Al₂O₃ (NPL 8). The deconvolution of Fe3p peak to Fe²⁺ and Fe³⁺ peaks with atomic ratio of 1:2 (FIG. 3 (c)), in combination with the Al2p peak at 74.4 eV and the O1 s peak at 531.57 eV suggest the presence of spinel oxide FeAl₂O₄ in the inert shell (NPL 9 and 10).

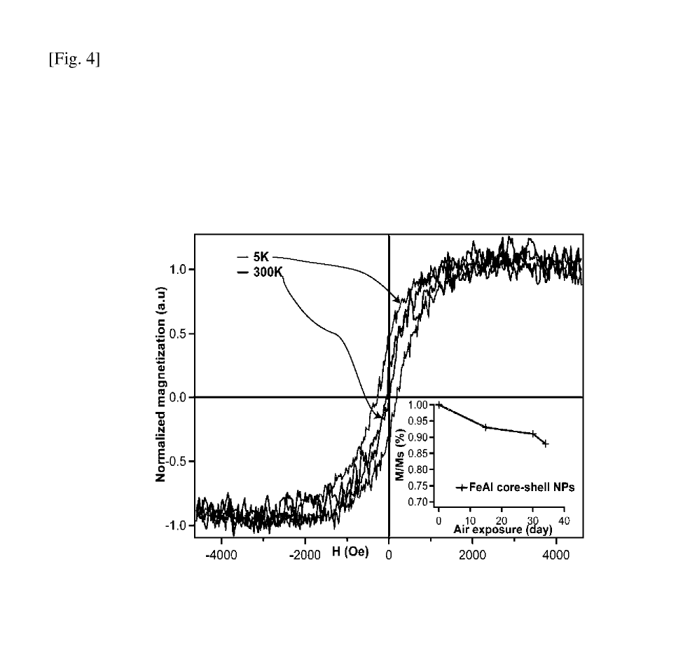

FIG. 4 is a normalized measured magnetization M (H) as a function of the applied magnetic field. The outer lines indicate the magnetization at 5K and the inner lines at 300 K. The nanoparticles show good stability against further oxidation (evaluated by measuring the normalized magnetization M/Ms as a function of time after exposure to air, as shown in the inset). The magnetization value is about 90 % of the initial Ms after 1 month. A typical ferromagnetic behavior was observed at low temperature (5K). The coercive field (Hc) decreases from 280 Oe to less than 20 Oe as the temperature increases from 5K to 300K, indicating a soft magnetic behavior. The saturation magnetization (Ms) is found to be 204 emu/g at 5K and 170 emu/g at 300K. These values are high compared to the Ms values reported so far for iron aluminide alloys (NPLs 11-13), and is higher than that of iron oxide nanoparticles with similar size (typically range from 70-110 emu g¹) (NPLs 14 and 15). Interestingly, our iron aluminide nanoparticles display high stability against oxidation compared to other iron-based nanoparticles reported in literature, as shown in FIG. 4, inset (NPLs 16-17). The low value below 0.5 (non-interacting particles) of the remainence ratio Mr/Ms in FIG. 4 could be explained simply by the effect of competition between the inter and intra particle interaction on the spin relaxation process (NPL 18) and as a result of the encapsulation by the alumina shell, which provides weak inter-particles interactions. All of these values are listed in Table 1 below.

TABLE 1

| T | Ms | Mr | | |
|---|---|---|---|---|
| (k) | (emu/g) | (emu/g) | Mr/Ms | Hc (Oc) |
| 5 | 204 | 91 | 0.45 | 280 |
| 300 | 170 | 25 | 0.15 | 20 |

Table 1 shows measured hysteresis loop parameters at 5K and 300K of the manufactured nanoparticles. Saturation magnetizations (Ms) and remanence magnetizations (Mr) are calculated using SEM distribution and XPS average composition (calculated error about +−10%). As shown in the measured data, the FeAl nanoparticle according to the embodiment of the present invention exhibit superior magnetization properties.

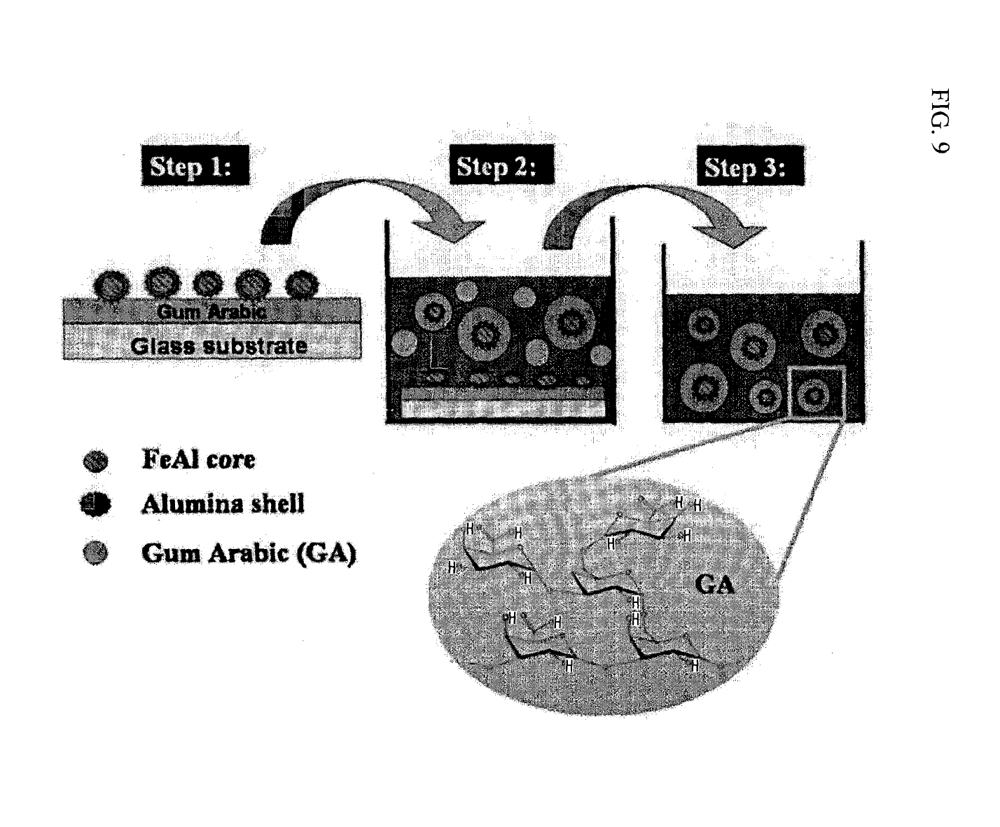

To stabilize the nanoparticles in water, the surface of these magnetic nanoparticles may be coated with a bio-polymer, such as gum arabic (GA) for potential applications in biomedicine (NPL 19). The details of the coating process will be explained with reference to FIG. 9 below.

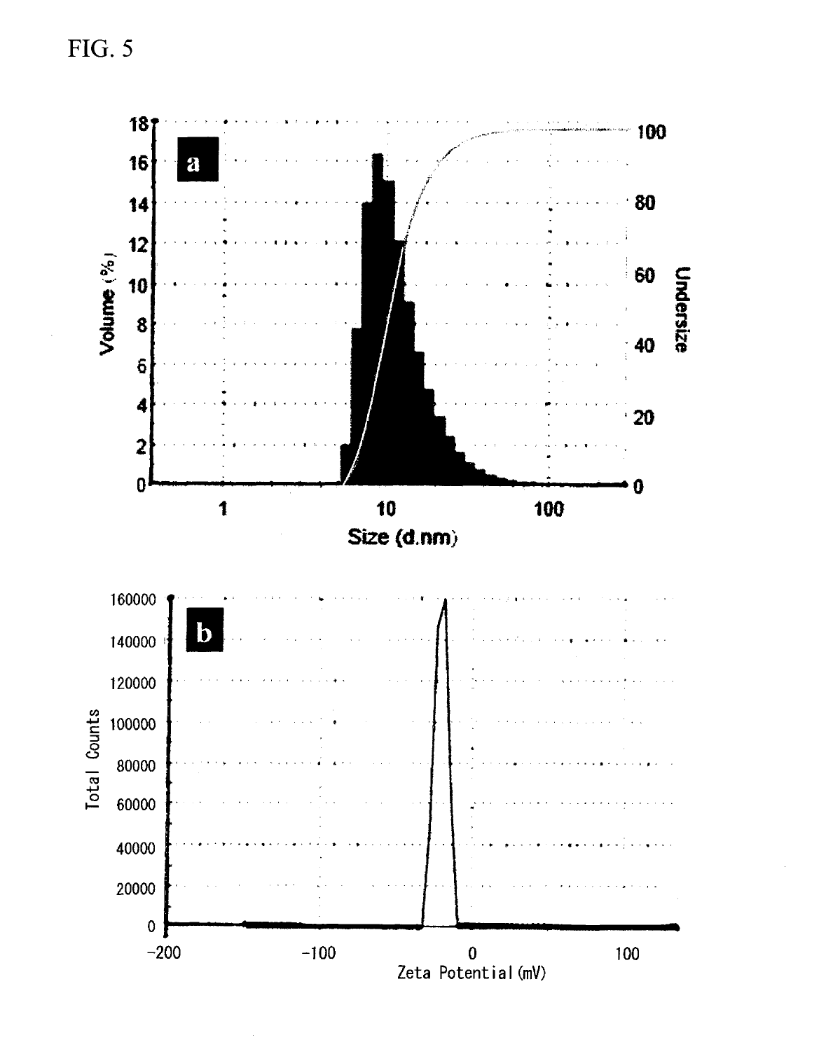

The size distribution and the colloidal stability of GA coated iron aluminide nanoparticles according to an embodiment of the present invention in water were evaluated using dynamic light scattering (DLS) and zeta potential measurements. The results are shown in FIG. 5, (a) and (b). The size distribution obtained is in agreement with FIG. 1, (b), and a zeta potential value of −21 mV, indicates a stable colloidal dispersion (NPL 20).

As described above, in one aspect of the present invention, a novel approach for the synthesis of soft magnetic alloy nanoparticles has been disclosed herein. This approach is general and can be applied to a wide range of materials. Iron aluminide nanocrystals encapsulated in alumina shell have been demonstrated. The high saturation magnetization and low corecivity of these nanoparticles make the manufactured nanoparticles a very promising candidate as soft magnetic materials for future nanotechnology and biomedical applications, such as writing heads for magnetic recoding devices and local hyperthermia for cancer treatment.

### Setup and Conditions for Manufacturing FeAl Nanoparticles

The FeAl nanoparticles, as described above, were obtained using a modified inert-gas condensation magnetron sputtering apparatus shown in FIG. 6. FIG. 6 is a schematic diagram of the modified inert-gas condensation magnetron co-sputtering apparatus. FIG. 6 shows two Fe targets and one Al target. The diagram is divided into three parts: an aggregation zone where nucleation of Fe and Al clusters took place, followed by coalescence to produce larger nanoparticles; an aperture through which the as-nucleated alloy nanoparticles pass to create a nanocluster beam; and a main chamber to which the nanocluster beam of the nanoparticles directed to deposit the nanoparticles on the substrate. A supersaturated vapor of metal atoms is generated by co-sputtering in an argon (Ar) atmosphere. The aggregation chamber is water-cooled and evacuated down to about 10⁻⁶ mbar, prior to sputtering. High-purity Fe (99.9%) and Al (99.9995%) targets were used in the DC co-sputtering process. The constant pressure process was maintained at 3×10₋₁ mbar in the aggregation zone and 8.4×10⁻⁴ mbar in the main chamber, and the Ar flow rate was set to 80 sccm. This differential pressure is a key factor, which determines the residence time in the aggregation zone, and therefore, affects the crystallinity, size, and shape of the nanoparticles. The DC power applied to the one inch Fe and Al targets was fixed at 11 W and 16 W respectively. Due to the difference in atomic mass (Al: 1.426 angstroms and Fe: 1.124 angstroms) (NPL 21) and sputtering yields (Al: 0.42 and Fe: 0.47), the power for Al is higher than to that for Fe. The power ratio was fixed in order to work in the Fe-rich part of the Fe—Al binary phase diagram where the DO₃ and A2 phases are growth and stable at low-temperature (<500 degrees in Celsius). The nanoparticles are deposited on silicon substrates and silicon nitride TEM window grids for characterization. The aggregation zone length is set to 90 mm and the substrate is rotated during deposition. The size, morphology and crystal structure of these intermetallic nanoparticles were examined using a scanning electron microscope (SEM) FEI Quanta FEG 250 and an image-corrected scanning/transmission electron microscope (S/TEM) FEI Titan 80-300 kV operated at 300 kV. Electron energy loss spectroscopy (EELS) was performed to study individual NPs' composition using a Gatan GIF Quantum imaging filter. The chemical composition and oxidation coating of these samples were also evaluated using X-ray photoelectron spectroscopy (XPS) Kratos Axis UltraDLD 39-306 equipped with a mono AlK-alpha source operated at 300 W. Magnetization measurements as a function of the field and temperature were performed using a Cryogen-free physical property measurement system (PPMS) DynaCool from Quantum Design in a vibrating sample magnetometer mode (VSM).

### EELS Measurements

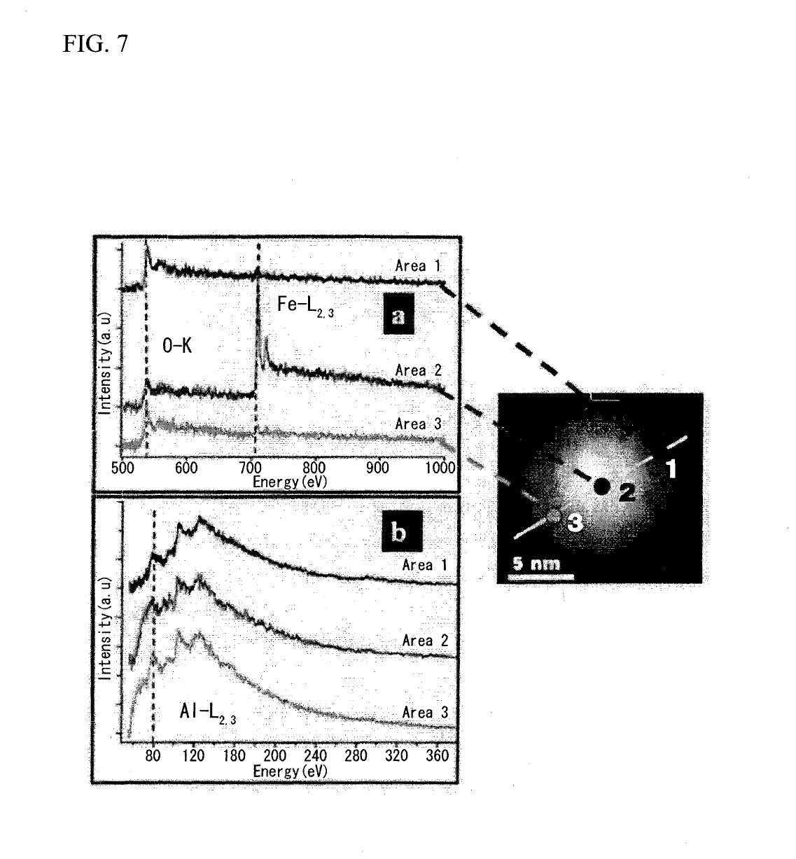

FIG. 7 shows EELS spectra obtained from different areas of the representative nanoparticles according to the embodiment of the present invention. The nanoparticle is composed of a bright core surrounded by a shell which is less shiny. The identification of each element depends on the difference in contrast in ADF image which is related to the atomic number. The presence of an Fe—Al core rich in Fe is demonstrated by the bright contrast. Spatially resolved chemical information from these nanoparticles was acquired by obtaining electron energy loss spectrum from a series of points across the representative NP in a STEM configuration, as shown in the left image of FIG. 7. FIG. 7, (a) shows core-loss spectra for the measured areas 1-3, and (b) shows low-loss spectra for the areas 1-3. STEM-EELS spectrum of the areas 1-3 show the presence of Fe, Al and O within the NP. As can be seen in (a) and (b), the area 1 shows a strong edge of Fe-L₂,₃ corresponding to the position of the bright core, while the spectra on either side (area 2 and area 3) of the core are dominated by Al-L₂,₃ and O—K edge.

### Crystal Structure

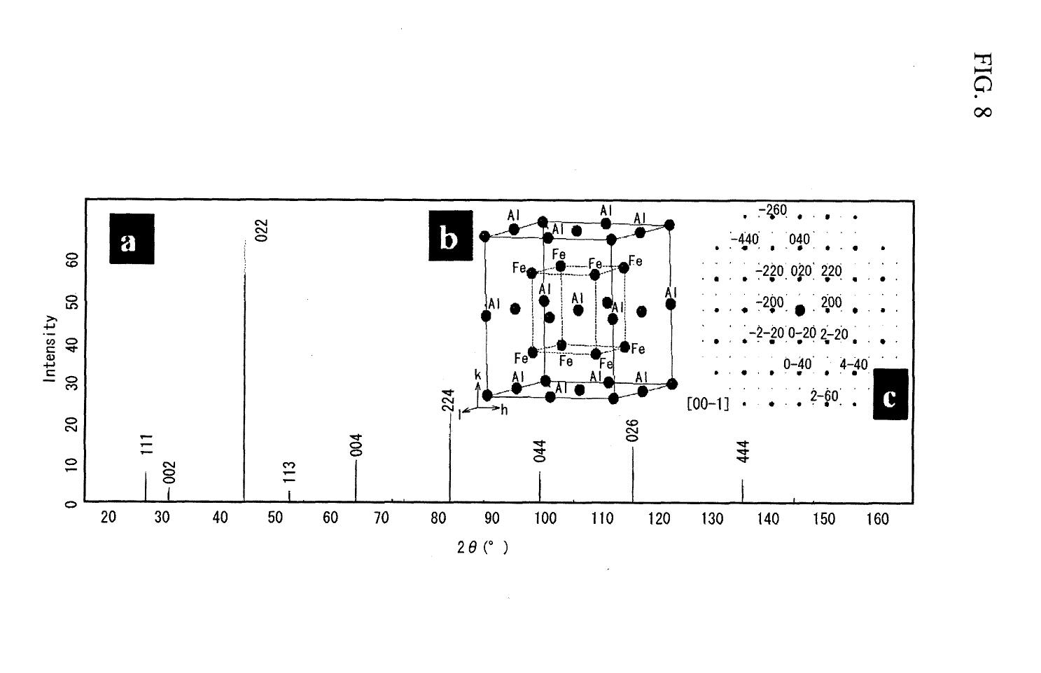

FIG. 8 shows simulated X-ray powder diffraction pattern (a) of the DO₃ structure (b) and the corresponding electron diffraction pattern in [00-1] zone axis (c), obtained using Crystal maker(TM) software. The DO₃ is a derivative-bcc structure consisting in four interpenetrating fcc sublattices. The reflections in the FFT analysis (FIG. 2, (b)) are comparable to those reflections in the simulated diffraction pattern in FIG. 8. It can be seen that all of the calculated lattices spacing and angles in the FFT (FIG. 2) matches perfectly with those values obtained by Crystal Make™ (Table 2). Table 2 shows calculated values from the FFT analysis and simulated values by Crystal Maker(TM) of the corresponding d-spacing and angles. Further, the calculated lattice parameter with experimental d-spacing (5.769) is in good agreement with the known lattice parameter (5.792) (NPL 22). It is important to note that the small difference in lattice parameter can be explained by compressive strain in small size nanoparticles.

TABLE 1

| DO₃ phase | Calculated from FFI (FIG. 2) | | Simulated values | |
|---|---|---|---|---|
| bkl | d_{bkl} (Å) | angles (deg.) | d_{bkl} (Å) | angles (deg.) |
| 220 | 2.04 | 46 | 2.0478 | 45 |
| 400 | 1.46 | | 1.448 | |
| 220 | 2.04 | 26 | 2.0478 | 26.57 |
| 620 | 0.93 | | 0.9158 | |
| 400 | 1.46 | 20 | 1.448 | 18.43 |
| 620 | 0.93 | | 0.9158 | |
| 220 | 2.04 | 90 | 2.0478 | 90 |
| 440 | 1.025 | | 1.0239 | |

### Harvesting Procedure

FIG. 9 schematically shows a harvesting procedure employed for the magnetic nanoparticles coated with Gum Arabic (GA).

### Step 1

To form a gum arabic (GA) film, a glass slide substrate (76 mm×26 mm) was thoroughly rinsed in dry ethanol for 10 min under ultrasonication, then dried under N₂ gas. 10 mg of GA (Sigma-Aldrich, St. Louis, US) was dispersed in 250 μL of deionized (DI) water solution and gently dispensed onto the cleaned glass substrate. A thin GA film was formed by a spin-coater (MS-A-150, MIKASA, Japan) operated at 3,000 rpm for 30 sec.

### Step 2

NPs were exfoliated by immersing the NPs/GA/glass samples in DI water and sonicating for 15 min, followed by a separation step to remove the excessive GA polymer using a centrifuge at 100,000 rpm for 60 min.

### Step 3

After washing the precipitated NPs with 50% methanol in DI water, the NPs were redispersed in DI water from a Milli-Q system (Nihon Millipore K. K., Tokyo, Japan) using 0.1 μm filters.

The present disclosure describes the design and assembly of stable soft magnetic alloy nanoparticles. A number of diagnostic methods were utilized for their characterization. Embodiments of the present invention have a wide range of biomedical and other technological applications.

It will be apparent to those skilled in the art that various modification and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

1. A soft magnetic nanoparticle comprising an iron aluminide nanoalloy of the DO₃ phase as a core encapsulated in an inert shell made of alumina.

2. The soft magnetic nanoparticle according to claim 1, further comprising a polymer coating thereon.

3. The soft magnetic nanoparticle according to claim 2, wherein the polymer is Gum Arabic (GA).

4. The soft magnetic nanoparticle according to claim 1, wherein the nanoparticle has a saturation magnetization equal to about 170 emu/g or greater at 300K and a coercivity of about 20 Oe or less at 300K.

5. The soft magnetic nanoparticle according to claim 1, wherein the core made of iron aluminide is in a crystalline phase, and the inert shell is in an amorphous phase.

6. A method for forming soft magnetic nanoparticles each comprising an iron aluminide nanoalloy of the DO₃ phase as a core encapsulated in an inert shell made of alumina, the method comprising:
producing a supersaturated vapor of metal atoms of Al and Fe in an aggregate zone by co-sputtering Fe atoms and Al atoms in an Ar atmosphere;
producing larger nanoparticles from the supersaturated vapor;
causing the larger nanoparticles to pass through an aperture with a pressure differential before and after the aperture so as to create a nanocluster beam of the nanoparticles emerging from the aperture; and
directing the nanocluster beam to a substrate to deposit the nanoparticles onto the substrate.

7. the method according to claim 6, wherein the step of producing the super saturated vapor includes applying separate magnetron powers to an Al target and to and Fe target for sputtering.

8. The method according to claim 6, further comprising exposing the nanoparticles deposited on the substrate to oxide to oxidize a surface of the nanoparticles.
